(19) United States
(12) Patent Application Publication
(10) Pub. No.: US 2009/0238669 A1
(43) Pub. Date: Sep. 24, 2009

(54) VEHICLE, SYSTEM AND METHOD FOR HANDLING CARGO CONTAINERS

(76) Inventors: RICHARD C. HATHAWAY, Greenville, OH (US); M. Kent Bridges, New Madison, OH (US)

Correspondence Address: James Ray & Associates, 2640 Pitcairn Road, Monroeville, PA, 15146, US

(21) Appl. No.: 12/406,531

(22) Filed: Mar. 18, 2009

Related U.S. Application Data
(60) Provisional application No. 61/069,847, filed on Mar. 18, 2008.

(51) Int. Cl. B60P 1/43; B61D 17/00

(52) U.S. Cl. 414/539; 105/404; 414/812

(57) ABSTRACT

A system for handling cargo containers includes at least one intermodal railroad car having a pair of longitudinal ramps and a pair of tapered ends, at least one vehicle connectable to a cargo container and having ground engaging wheels mounted in a spaced apart relationship for travel on the pair of longitudinal ramps and further having linear actuators for moving the cargo container in a vertical direction, and at least one cargo handling terminal enabling movement of the at least one vehicle onto and from each of the pair of longitudinal ramps and the pair of ends for loading the cargo container onto and unloading the cargo container from the at least one intermodal railroad car. A vehicle adapted for travel on both ground surface and rail track and a method for transporting cargo using such vehicle are also provided.

### CROSS-REFERENCE TO RELATED APPLICATIONS

This application is related to and claims priority from Provisional Patent Application Ser. No. 61/069,847 filed on Mar. 18, 2008.

### FIELD OF THE INVENTION

This invention relates to a vehicle, system and method for handling one of containers used to haul cargo in marine vessels and the trailer portion of a tractor trailer combination.

### BACKGROUND OF THE INVENTION

As is generally well known, handling containers used to haul cargo in marine vessels or the trailer portion of a tractor trailer combination between a pair of terminals is a multi step process. For example, in applications involving marine vessels, the container is first removed, usually by a crane, from the marine vessel and is set on the ground surface in a generally close proximity to such vessel. Due to limited storage area in such close proximity to the marine vessel, the container may be moved to a different location within marine port by a specialty vehicle. Then, the container is loaded, either by such specialty vehicle or a crane, onto a railcar usually in a side loading manner. To maximize loading capacity, the container is loaded into a well car and, furthermore, a second container is also loaded and is stacked on a top of a lower container. The container(s) is(are) then transported by the railcar to a remote inland terminal, where each container is unloaded by specialized vehicle, again from the side of the railcar, and is moved to a predetermined position for future handling. Or, the container is unloaded by a crane and is placed onto a specialized dolly that is then connected to a truck. Thus, the loading, transportation and unloading of the container requires greater than desirable number of steps and vehicles thus resulting in inefficient and expensive process.

Therefore, there is a need for an improved system and method of handling one of containers used to haul cargo in marine vessels and the trailer portion of a tractor trailer combination.

### SUMMARY OF THE INVENTION

In a first aspect, the present invention provides a system for handling at least one of a container used to haul cargo in marine vessels and a trailer portion of a tractor trailer. The system includes at least one intermodal railroad car having a pair of longitudinal ramps and a pair of ends, each of the pair of ends having a pair of tapered side edges converging in a substantially horizontal plane to form an angle of the each end of about ninety degrees. There is at least one vehicle releasably connectable to the at least one of the container used to haul cargo in marine vessels and the trailer portion of the tractor trailer and having at least a predetermined plurality of ground engaging wheel assemblies mounted on each side of the at least one vehicle in a spaced apart relationship for travel on the pair of longitudinal ramps and further having means for moving the at least one of the container used to haul cargo in marine vessels and the trailer portion of the tractor trailer in a vertical direction. At least one cargo handling terminal is provided and enables movement of the at least one vehicle onto and from each of the pair of longitudinal ramps and the pair of ends for at least one of loading the at least one of a container used to haul cargo in marine vessels and a trailer portion of a tractor trailer onto and unloading the at least one of a container used to haul cargo in marine vessels and a trailer portion of a tractor trailer from the at least one intermodal railroad car.

In another aspect, the present invention provides a railroad car for handling at least one of a container used to haul cargo in marine vessels and a trailer portion of a tractor trailer. The railroad car includes a cargo receiving portion and a pair of longitudinal ramps, each of the pair of longitudinal ramps having a proximal edge thereof extending along one side of the cargo receiving portion. There is a pair of barriers, each of the pair of barriers disposed in a vertical plane and having a lower edge thereof secured to a distal end of one longitudinal ramp. There is also a pair of end sills, each of the pair of end sills having each of a proximal end thereof extending along one end of the cargo receiving portion, a distal end formed by a pair of tapered edges converging in the horizontal plane to form an angle of the distal end of about ninety degrees, a top planar surface disposed substantially planar with a top planar surface of the each of the pair of longitudinal ramps, and a pair of side edges, each of the pair of side edges aligned with one distal edge of the longitudinal ramp.

In yet another aspect, the present invention provides a vehicle for handling at least one of a container used to haul cargo in marine vessels and a trailer portion of a tractor trailer. The vehicle includes a substantially rectangular frame disposed in a horizontal plane, the frame having a pair of ends and a pair of sides defining a central opening thereof, the central opening sized to receive the at least one of the container and the trailer portion therewithin. An operating cab is mounted on one end of the frame. A predetermined plurality of ground engaging wheel assemblies are mounted on each side of the frame. There is means for generating motive power to at least a pair of the predetermined plurality of ground engaging wheel assemblies. There is also means for moving the at least one of the container and the trailer portion received within the central opening in a vertical direction.

In a further aspect, the present invention provides a vehicle for handling at least one of a container used to haul cargo in marine vessels and a trailer portion of a tractor trailer. The vehicle includes a body. A predetermined plurality of ground engaging wheel assemblies are mounted on both sides of the body. There is means for generating motive power to at least a pair of the predetermined plurality of ground engaging wheel assemblies. There is also means for moving the at least one of the container used to haul cargo in marine vessels and the trailer portion of tractor trailer in a vertical direction, the means including each of a vertically disposed member mounted for a linear movement on an opposed end of the body, a pair of locking fittings mounted at an upper end of the member for locking engagement with a respective corner fitting disposed on the at least one of the container and the trailer portion and at least one vertically disposed linear actuator having a terminal end of a stationary portion thereof secured to the opposed end of the body and having a terminal end of a movable portion thereof secured to the member.

In another aspect, the present invention provides a method for transporting at least one of a container used to haul cargo in marine vessels and a trailer portion of a tractor trailer between a pair of cargo handling terminals. The method includes the step of providing a powered vehicle having each of ground surface engaging wheels, rail track engaging wheels, means for connecting to the at least one of the container used to haul cargo in marine vessels and the trailer portion of the tractor trailer, and means for reciprocally moving the at least one of the container used to haul cargo in marine vessels and the trailer portion of the tractor trailer in a vertical direction. Then, configuring the vehicle for travel on the ground surface. Next, connecting the vehicle to the at least one of the container used to haul cargo in marine vessels and the trailer portion of the tractor trailer. Elevating the at least one of the container used to haul cargo in marine vessels and the trailer portion of the tractor trailer a predetermined distance above ground surface. Then, traveling, by the vehicle, to a rail head located at one of the pair of cargo handling terminals. Next, reconfiguring the vehicle for travel on the rail track. Transporting the at least one of the container used to haul cargo in marine vessels and the trailer portion of the tractor trailer to an opposed one of the pair of cargo handling terminals. Next, reconfiguring the vehicle for travel on the ground surface. Then, traveling, by the vehicle, to a predetermined location in the opposed one of the pair of cargo handling terminals. Lowering, with the vehicle, the at least one of the container used to haul cargo in marine vessels and the trailer portion of the tractor trailer onto a ground surface of the opposed one of the pair of cargo handling terminals. Finally, disconnecting the vehicle from the at least one of the container used to haul cargo in marine vessels and the trailer portion of the tractor trailer.

In another aspect, the present invention provides a method for transporting at least one of a container used to haul cargo in marine vessels and a trailer portion of a tractor trailer between a pair of cargo handling terminals. The method includes the step of providing a powered vehicle having each of ground surface engaging wheels, means for connecting to the at least one of the container used to haul cargo in marine vessels and the trailer portion of the tractor trailer and means for reciprocally moving the at least one of the container used to haul cargo in marine vessels and the trailer portion of the tractor trailer in a vertical direction. Next, providing at least one intermodal railroad car having a pair of longitudinal side ramps and a pair of ends surrounding a cargo receiving portion, each of the pair of ends having a pair of tapered side edges converging in a substantially horizontal plane to form an angle of the each end of about ninety degrees. Then, providing, at least one cargo handling terminal having a pair of platforms disposed in a parallel spaced relationship to each other. Configuring a portion of a continuous railroad track disposed between the pair of platforms into a predetermined plurality of track sections disposed at each of a first angle of about ninety degrees to each other and at a second angle of about forty five degrees to a side edge of each of the pair of platforms. Next, connecting the vehicle to the at least one of the container used to haul cargo in marine vessels and the trailer portion of the tractor trailer. Then, elevating, with the reciprocally moving means of the vehicle, the at least one of the container used to haul cargo in marine vessels and the trailer portion of the tractor trailer a predetermined distance above ground surface. Transporting, by the vehicle, the at least one of the container used to haul cargo in marine vessels and the trailer portion of the tractor trailer onto the at least one intermodal railroad well car. Next, depositing, with the reciprocally moving means of the vehicle, the at least one of the container used to haul cargo in marine vessels and the trailer portion of the tractor trailer onto the cargo receiving portion. Finally, transporting, by the at least one intermodal railroad well car, the at least one of the container used to haul cargo in marine vessels and the trailer portion of the tractor trailer to an opposed one of the pair of cargo handling terminals.

### OBJECTS OF THE INVENTION

It is, therefore, one of the primary objects of the present invention to provide a system for handling one of containers used to haul cargo in marine vessels and the trailer portion of a tractor trailer combination that utilizes a self-loading vehicle.

Another object of the present invention is to provide a system for handling one of containers used to haul cargo in marine vessels and the trailer portion of a tractor trailer combination that utilizes a modified well or flat bed railcar capable of supporting a loading vehicle.

Yet another object of the present invention is to provide a system for handling one of containers used to haul cargo in marine vessels and the trailer portion of a tractor trailer combination that utilizes a modified well or flat bed railcar that can be loaded or unloaded from the end.

A further object of the present invention is to provide a system for handling one of containers used to haul cargo in marine vessels and the trailer portion of a tractor trailer combination that employs a pair of loading platforms and a track portion disposed to enable end loading and unloading of a railcar.

Yet a further object of the present invention is to provide a system for handling one of containers used to haul cargo in marine vessels and the trailer portion of a tractor trailer combination that employs specialized vehicle adapted for travel on each of the ground surface and rail track.

An additional object of the present invention is to provide a method of utilizing the above described system for handling one of containers used to haul cargo in marine vessels and the trailer portion of a tractor trailer combination.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWING FIGURES

FIG. 1 illustrates planar view of a system of the present invention for handling one of containers used to haul cargo in marine vessels and the trailer portion of a tractor trailer combination;

FIG. 2 is a partial side elevation of the system of FIG. 1;

FIG. 3 is a side elevation of the system of FIG. 1, particularly illustrating an intermodal railroad car of the present invention;

FIG. 4 is a planar view of the intermodal railroad car of FIG. 3;

FIG. 5 is a cross-sectional view of the intermodal railroad car along lines V-V of FIG. 2;

FIG. 6 is a cross-sectional view of the intermodal railroad car along lines VI-VI of FIG. 2;

FIG. 7 is a side elevation of the system of FIG. 1, particularly illustrating a vehicle for loading and unloading containers which is constructed in accordance with one embodiment of the present invention;

FIG. 8 is a rear elevation view of the vehicle of FIG. 7;

FIG. 9 is a planar view of a railroad track layout employed in the system of FIG. 1;

FIG. 10 is a side elevation view illustrating the vehicles of FIG. 7 ready to be backed into a position to raise a pair of containers;

FIG. 11 is a side elevation view illustrating containers being raised by the vehicles of FIG. 7;

FIG. 12 is a side elevation view illustrating containers being set into a well car;

FIG. 13 is a side elevation illustrating a pair of vehicles for loading and unloading containers which is constructed in accordance with another embodiment of the present invention;

FIG. 14 is an end view of the vehicle of FIG. 13;

FIG. 15 illustrates an alternative embodiment of the vehicle of FIG. 13;

FIG. 16 is an end view of the vehicle of FIG. 15;

FIG. 17 illustrates another alternative embodiment of the vehicle of FIG. 13;

FIG. 18 is an end view of the vehicle of FIG. 17;

FIG. 19 is a planar view of a system of the present invention for handling one of containers used to haul cargo in marine vessels and the trailer portion of a tractor trailer combination using the vehicles of FIG. 13.

FIG. 20 is a partial side elevation view of the system of FIG. 19;

FIG. 21 is a planar view of a vehicle for loading and unloading containers which is constructed in accordance with yet another embodiment of the present invention;

FIG. 22 is a side elevation view illustrating a vehicle for loading and unloading containers which is constructed in accordance with a further embodiment of the present invention which has a split frame having a rear portion illustrated in raised position;

FIG. 23 is a side elevation view of the vehicle of FIG. 22 with the ear portion of the frame lowered into position to pick up the container;

FIG. 24 is a side elevation view showing the frame illustrated in FIG. 22 shortened in length to accommodate the size of the container to be moved;

FIG. 25 is a side elevation view showing the container illustrated in FIG. 24 in a lifted position and with the ground engaging wheels lowered;

FIG. 26 is a side elevation view showing the container illustrated in FIG. 24 in a lifted position and with both the ground engaging wheels and rail engaging wheels lowered;

FIG. 27 is a side elevation view showing the container illustrated in FIG. 24 in a lifted position and with the ground engaging wheels raised and rail engaging wheels lowered; and

FIG. 28 is a schematic diagram illustrating a plurality of vehicles of FIGS. 21 or 22 connected into a train consist.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

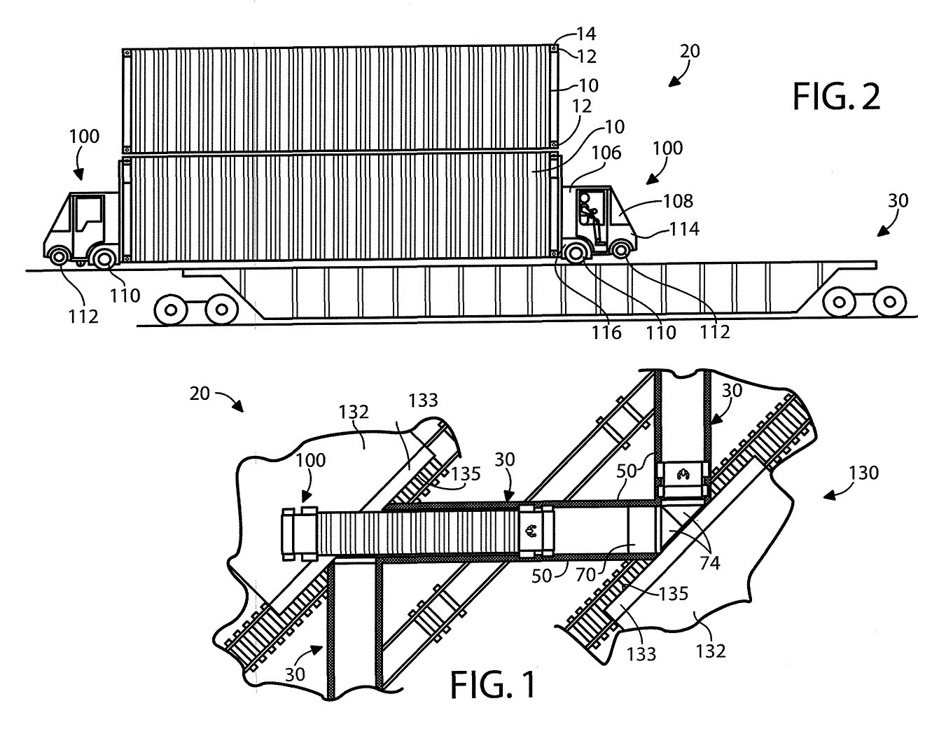

Now in reference to FIGS. 1-?, therein is shown a system, generally designated as 20, for handling at least one of a container used to haul cargo in marine vessels and a trailer portion of a tractor trailer.

The system 20 will be illustrated and described in combination with the container 10 used to haul cargo in marine vessels, although it will be apparent to those skilled in the relevant art that the present invention may be applied to a trailer portion of a tractor trailer and as such should not be interpreted as a limiting factor of the system 20 of the present invention.

To aid the reader in understanding the structure and operation of the present invention, it is noted that the container 10 has a corner fitting 12 disposed at each corner thereof. The fitting 12, has a trio of apertures 14 (only one of which is shown), each formed through one leg of the corner fitting 12 for receiving a locking pin therethrough.

The system 20 includes at least one intermodal railroad car, generally designated as 30, at least one vehicle, generally designated as 100, that can be connected, in a releaseable manner, to such container 10 and at least one cargo handling terminal, generally designated as 130. Preferably, the intermodal railroad car 30 is designed to operate in multiple numbers forming a dedicated train consist that can be loaded and unloaded rapidly.

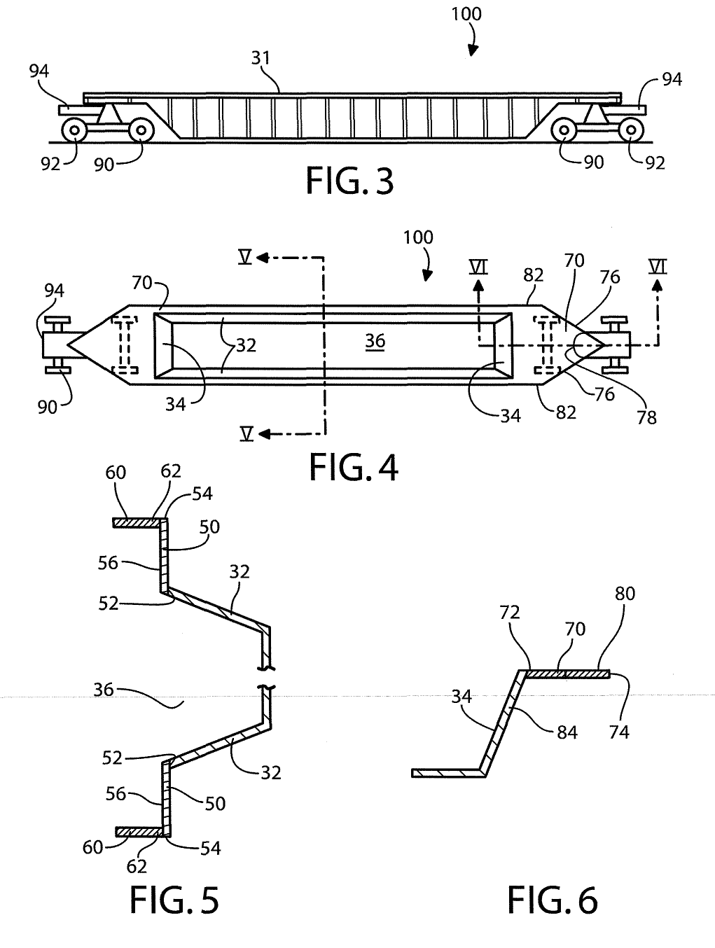

The intermodal railroad car 30 has a cargo receiving portion 31, which may have a generally planar surface (flat bed) for carrying a single container thereon. The present invention also contemplates and is described below in combination with an intermodal railroad well car. Such intermodal railroad well car, best shown in FIGS. 3-6 is constructed generally identical to conventional well cars in that cargo receiving portion 31 includes a pair of side walls 32, a pair of end walls 34 and a well 36 defined by a combination of the side and end walls, 32 and 34 respectively, for receiving the container 10 therein. Accordingly, the bottom wall 38 of the well 36 is adapted for securing the container 10 at fittings 12 during transport. However, the intermodal railroad well car 30 of the present invention includes several novel features.

First, there is a pair of longitudinal ramps 50. Each longitudinal ramp 50 has a proximal edge 52 thereof extending along and rigidly secured to one side wall 32 at a top edge 40 thereof. Each longitudinal ramp 50 also extends outwardly, in a horizontal plane, from the side wall 32.

Second, there is a pair of barriers 60. Each barrier 60 is disposed in a vertical plane and has a lower edge 62 thereof secured to a generally straight distal end 54 of one longitudinal ramp 50.

Furthermore, there is a pair of end sills 70. Each end sill 70 has a proximal end 72 thereof extending along and rigidly secured to each of the end wall 34 at a top edge 42 thereof and extends outwardly in a horizontal plane therefrom. A distal end 74 of the end sill 70 is formed by a pair of tapered edges 76 converging in the horizontal plane to form an angle 78 of the distal end 74 of about ninety degrees. A top planar surface 80 of the end sill 70 is disposed substantially planar with a top planar surface 56 of each of the pair of longitudinal ramps 50. Generally straight side edges 82 of each end sill 70 are aligned with respective distal side edge 54 of the longitudinal ramp 50. The bottom surface 84 of each end sill 70 is inclined from the distal end 74 downwardly toward the end wall 34 at an angle to receive a bogie 90 of the well car 30 that essentially supports one end sill 70 thereon and is adapted with conventional wheels 92 for travel on a rail track. There is also means, for example, such as a pair of conventional couplers 94, each disposed at a respective end sill 70, for connecting the intermodal railroad well car 30 therebetween, to a conventional railroad car or to locomotive into a train consist.

Finally, at least the inner surfaces of the side and end walls, 32 and 34 respectively, are tapered inwardly to at least substantially minimize sliding of the container 10 during transport.

It is essential for the length of the intermodal railroad well car 30 to be less than sixty (60) feet between ends of the couplers 94 so as to meet various railroad rules and regulations.

The overall width of the intermodal railroad well car 30 should be approximately ten-and-a half (10.5) feet, to accommodate loading and unloading of the container 10 and the width of the well 36 which is approximately eight-and-a half (8.5) feet.

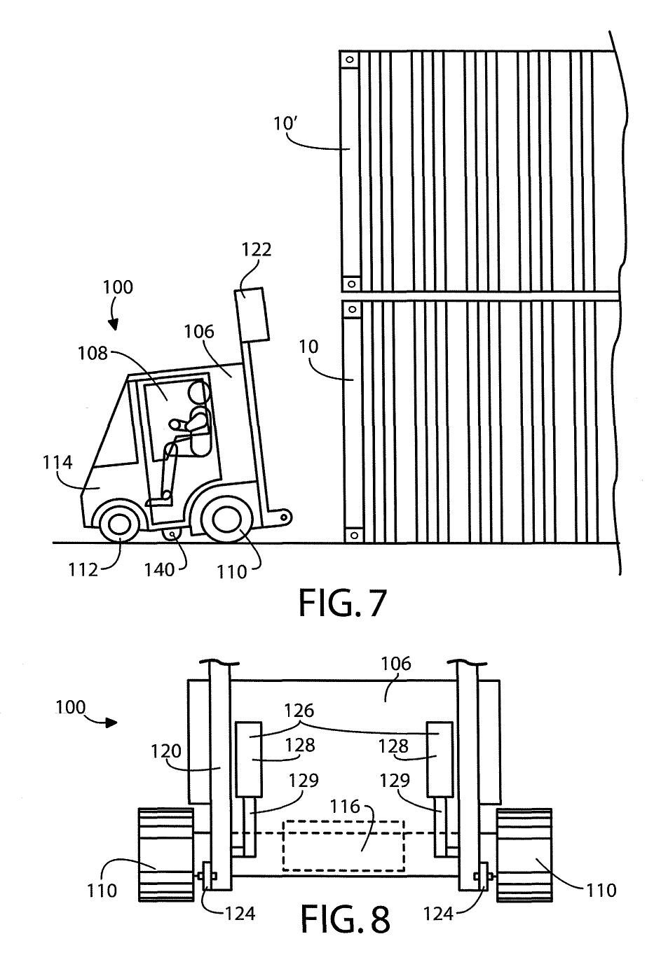

Now in reference to FIGS. 7-8, the system 20 also includes a vehicle, generally designated as 100, for loading the container 10 and unloading it from the well 36 of the intermodal railroad well car 30. The vehicle 100 includes an operating cab 108, although the present invention contemplates that the vehicle 100 may be provided as an automated guidance vehicle (AGV) in applications allowing use of a proper guidance system. The operating cab 108 is provided with necessary controls for the driver to operate the vehicle 100. There is a pair of driving and load carrying ground engaging wheels 110 which are positioned toward the rear end 106 of the vehicle 100. The wheels 110 are independently steered so as to improve maneuverability of the vehicle 100 similar to a “hook and ladder” fire trucks. There is also a pair of ground engaging idler wheels 112 that are mounted toward the front end 104 of the vehicle 100.

Means is provided for generating motive power to at least a pair of the predetermined plurality of ground engaging wheel assemblies 110. Such motive power means may be a conventional diesel power plant 114 that may be further integrated with the operating cab 108. Such motive power means may also include at least one electric motor 116 coupled to the pair of the ground engaging wheel assemblies 110 for enacting rotation thereof upon supply of electric power.

The vehicle 100 also includes means for moving one end of the container 10 in a vertical direction. By way of one example of FIG. 8, such means includes a vertically disposed member 120 mounted for a reciprocal linear movement in a vertical direction on the rear end 106. A pair of locking fittings 124 are provided with each locking fitting 124 mounted at each lower end of the member 120 for temporary locking engagement with the aperture 14 of a respective corner fitting 12. The locking fitting 124 may be of the type as manufactured by the TANDEMLOC, Inc of Havelock, N.C. At least one vertically disposed linear actuator 126 is also provided and has at least a terminal end of a stationary portion 128 thereof secured to the end 106 and has a terminal end of a movable portion 129 thereof secured to the member 120. The linear actuator 126 may be of any well known type, including pneumatic or hydraulic cylinder or electric drive. It is also contemplated to removably attach member 120 to the body 102, so that the member 120 may remain attached to the end of the container 10 in either a permanent or a semi-permanent manner. The lifting capability needs to be in excess of a combined 200,000 lbs load of a pair of containers 10, 10′.

Upper end 122 of each elongated member 120 may be also adapted with the locking fitting 124 or any other means for supporting the container 10.

The member 120 is designed and mounted on the rear end 106 so as to allow for a second container 10′ to be stacked on top of the container 10.

The wheel assemblies 110 are spaced apart in a direction transverse to the longitudinal axis of the container 10 for travel on the top planar surfaces 56 of the ramps 50 and top planar surfaces 80 of the end sills 70.

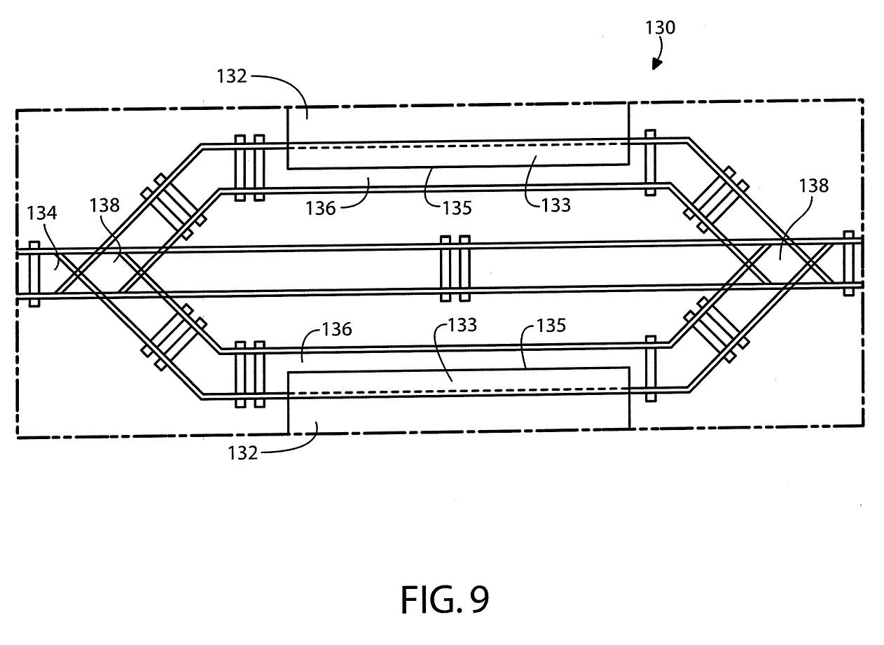

The present invention also provides for at least one cargo handling terminal 130, best shown in FIG. 9, for loading and unloading such container 10. Such cargo handling terminal 130 includes a pair of platforms 132 disposed in a parallel spaced relationship to each other. The distal end 133 of each platform 132 overhangs a portion of the track. Thus, the distal end 133 is either provided of a removable or pivotal type to facilitate track maintenance. A main railroad track 134, running mediate the pair of platforms 132, has a pair of parallel branches 136, each of such pair of branches 136 disposed adjacent a respective one of the pair of platforms 132. Each end of reach branch 136 is joined to the main track 134 with a railroad track switch 138. The railroad track switch 138 is of a conventional type and its description will be omitted in this document for the sake of brevity.

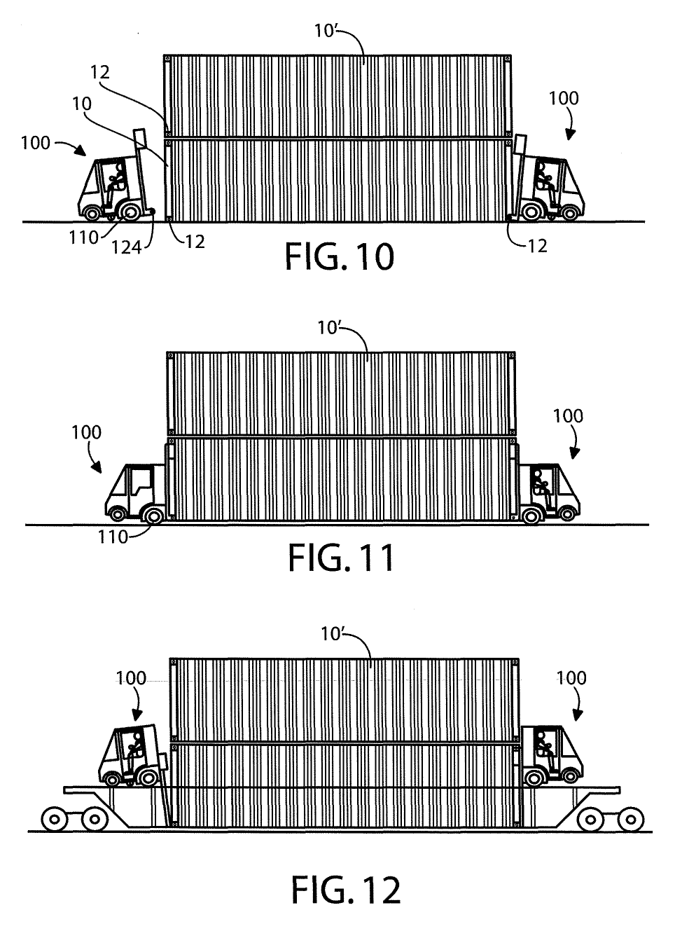

The operation of the system 20 will be described in reference to FIGS. 1-2 and 10-12.

As the train consist approaches the cargo handling terminal 130, each intermodal railroad well car 30 is switched at the first switch 138 so that one end of the intermodal railroad well car 30 travels on the track branch 136 disposed adjacent one of the pair of platforms 132, while the other end of the intermodal railroad well car 30 travels on the track branch 136 disposed adjacent an opposed one of the pair of platforms 132. The locomotive (not shown) travels on the main center track 134.

Each distal end 74 of the at least one intermodal railroad well car 30 is then disposed in close proximity to a respective side edge 133 of one of the pair of the platforms 132, wherein one of the pair of tapered edges 76 of each end sill 70 is disposed substantially parallel to such side edge 135 of the respective one of the pair of platforms 132. The height of each platform 132 is substantially identical to the height of the top planar surface 80 of the end sill 70 above top of rail. The length of the platform 132, particularly at its side edge 133, is selected to accommodate a predetermined number of intermodal railroad well cars 30 that can be loaded or unloaded without repositioning. It has been determined that a group of between eight (8) and ten (10) intermodal railroad well cars 30 is most advantageous to facilitate loading and unloading process. Thus, a number of intermodal railroad well cars 30 may be grouped into a mini train consist, wherein such intermodal railroad well cars 30 are coupled therebetween with couplers 94 that are less than conventional couplers to reduce both the weight and cost of each intermodal railroad well car 30. Then, the end sill 70 of each end intermodal railroad well car 30 will be equipped with conventional coupler 94.

Further, one vehicle 100 is connected to one end of the container 10. Another vehicle 100 is connected to an opposed end of the container 10. The container is elevated above the ground surface, in unison, by the pair of vehicles 100. When the container 10 is lifted, the each vehicle 100 is pivoted about its load carrying wheels 110. The container 10 (or a tandem of containers 10 and 10′) is transported, by the pair of vehicles 100 onto the at least one intermodal railroad well car 30. It would be understood that the ramps 50 are employed for allowing at least one vehicle 100 to travel along the side of the well 36. Advantageously, as best shown in FIG. 1, the articulation of pair of intermodal railroad well cars 30 join the tapered distal ends 74 of such pair of intermodal railroad well cars 30, so that the pair of vehicles 100 have full usage of the entire width of the end sill 70. The barriers 60 are of a sufficient height to prevent the vehicle 100 from driving off the side of the intermodal railroad well car 30.

After the container 10 is positioned about the well 36 it is lowered in unison by the pair of vehicles 100 and deposited into the well 36. Each vehicle 100 may be then disconnected from a respective end of the container 10 and exit the intermodal railroad well car 30. The train consist including the intermodal railroad well cars 30 of the present invention is then moved by the locomotive (not shown) to another container handling terminal where the container 10 is unloaded in a conventional manner.

The offloading of the container 10 will be achieved in a reverse manner, wherein each vehicle 100 is moved and coupled to one end of the container 10 which is then lifted, in unison, by the pair of vehicles 100 and is being transported off the intermodal railroad well car 30.

It is also within the scope of the present invention to allow the vehicles 100 to travel with the container 10 for unloading such container 10 at another cargo handling terminal 130 equipped with the pair of platforms 132 and the railroad track portion 134. This eliminates the need to reconnect the vehicles 100 for offloading purposes. When traveling with the container 10, the vehicles 100 is anchored down to the car 30 at anchor members 140, which may be a conventional eyelet.

After the intermodal railroad well cars 30 are loaded and/or unloaded, these cars are switched at the second railroad switch 138 into a conventional linear arrangement of the train consist.

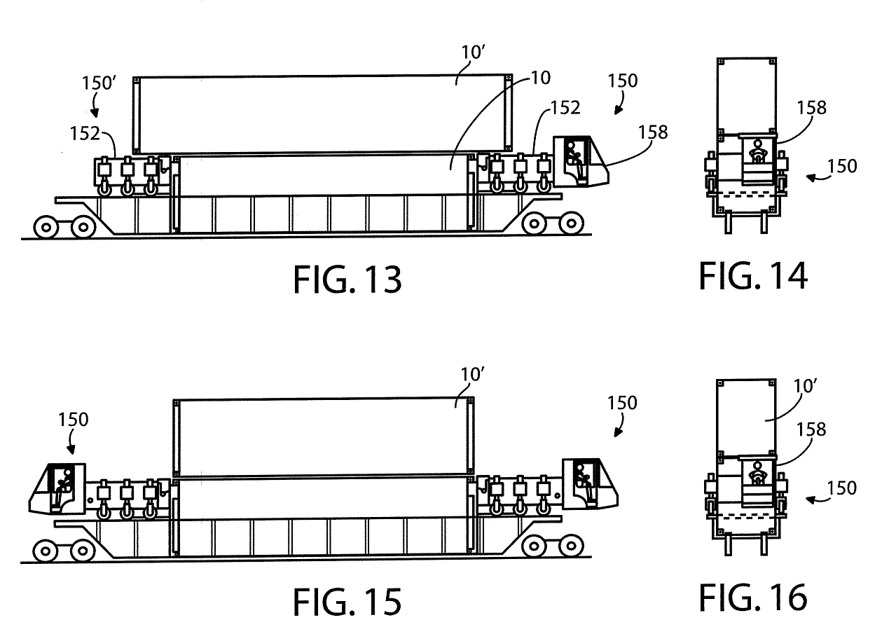

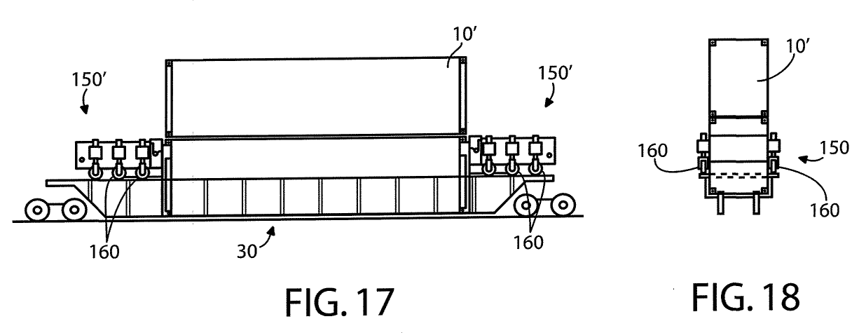

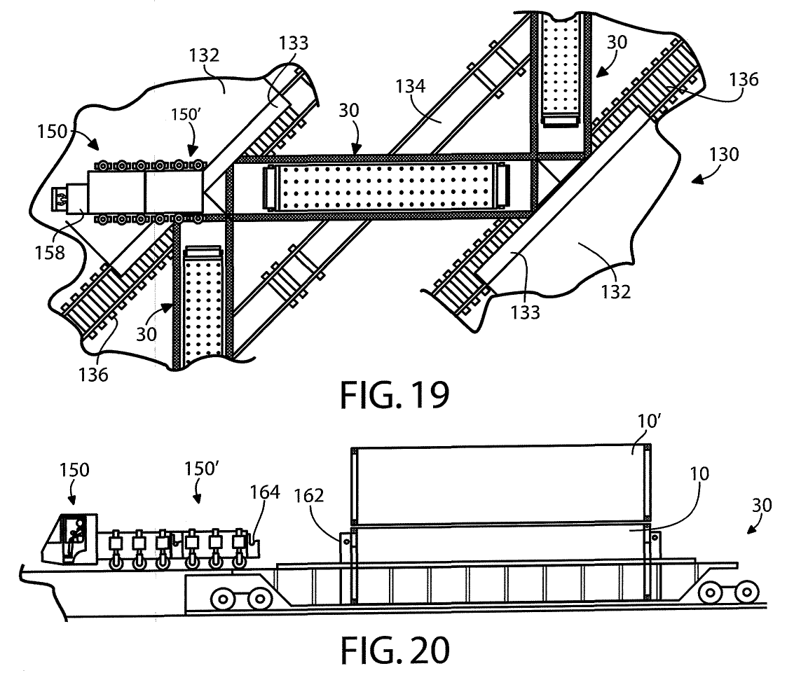

Now in further reference to FIGS. 13-20, the present invention provides a vehicle, generally designated as 150, which is constructed in accordance with another embodiment of the invention. The vehicle 150 has a body 152, an operating cab 158 mounted on one end of the body 152 and plurality of ground engaging wheels 160. The vehicle 150 may be also provided with out the operating cab 158 and is referenced, for the sake of clarity, with numeral 150′. The vehicle 150′ is essentially a slave to then leading vehicle 150. In this embodiment, both vehicles 150 and 150′ are provided with a coupling arrangement (not shown), so that both vehicles 150 and 150′ can travel as a tandem. Vehicle 150 will first position the vehicle 150′ at one end of the container 10 and then drive to the opposed side. The controls of the salve vehicle 150′ are adapted to be operable from the vehicles 150 for synchronous lifting and lowering of the container 10. Such tandem arrangement is particularly advantageous when the vehicles 150, 150′ are to remain with the container 10 during transport on the intermodal railroad well car 30.

A pair of lifting assemblies 162, each constructed substantially identical to the above described member 120 and 126 is provided at the rear end of the vehicle 150, 158′. It is also contemplated to retain such lifting assemblies 162 attached to the container 10 during transport and, thus, it is within the scope of the present invention to provide a coupling member 164, which may be a simple hook.

Preferably, the height of at least a portion of the vehicle 100 does not exceed four (4) feet at a distance of (4) feet from the end of the container 10. Thus, when a pair of containers 10, 10′ are transported in a vertically stacked arrangement, the length of the upper container 10 may greater than the length of the lower container, as best shown in FIG. 13. However, the height may increase beyond the (4) feet on a portion of the vehicle 150 which is outside of the length envelope if the upper container 10′. Thus, the cab 158 is positioned at a distance from the end of the lower container 10 so that its height can be greater than (4) feet to enhance operating conditions within the interior confines of the operating cab 158.

When containers 10 and 10′ are to be transported in a conventional vertically stacked tandem arrangement, the vehicles 150, 150′ will connect to the lower the container 10 having a smaller length. It is also within the scope of the present invention to transport a pair of stacked containers 10 having identical length. Thus, the above described system 20 can transport the following tandem configurations: forty (40) foot container below and forty (40) foot container above, twenty (20) foot container below and twenty (20) foot container above, forty (40) foot container below and two (2) twenty (20) foot containers above, and forty (40) foot container below and either a forty-five (45) or a forty-eight (48) foot container above.

Loading and unloading of the intermodal rail cars 30 using the vehicles 150, 150′ is achieved in a substantially identical manner to using the vehicles 100, 100′. Thus, the detail description of the operation is omitted for the sake of brevity.

In accordance with yet another embodiment of the invention, therein is provided a vehicle, generally designated as 200, that is capable of connecting to and transporting the container 10 over both the ground surface and rail track.

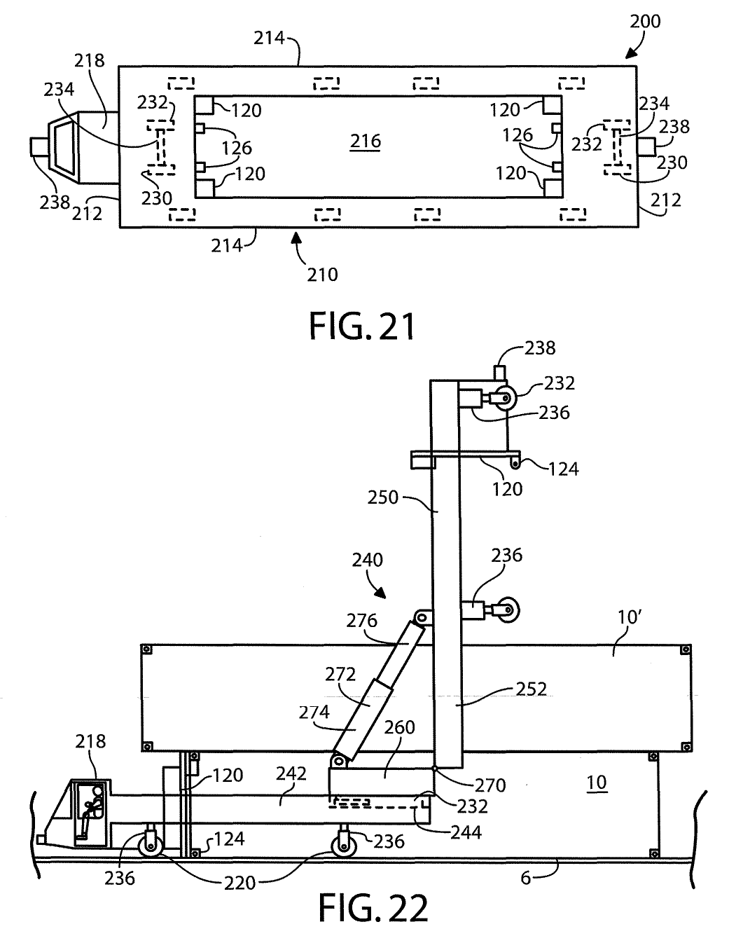

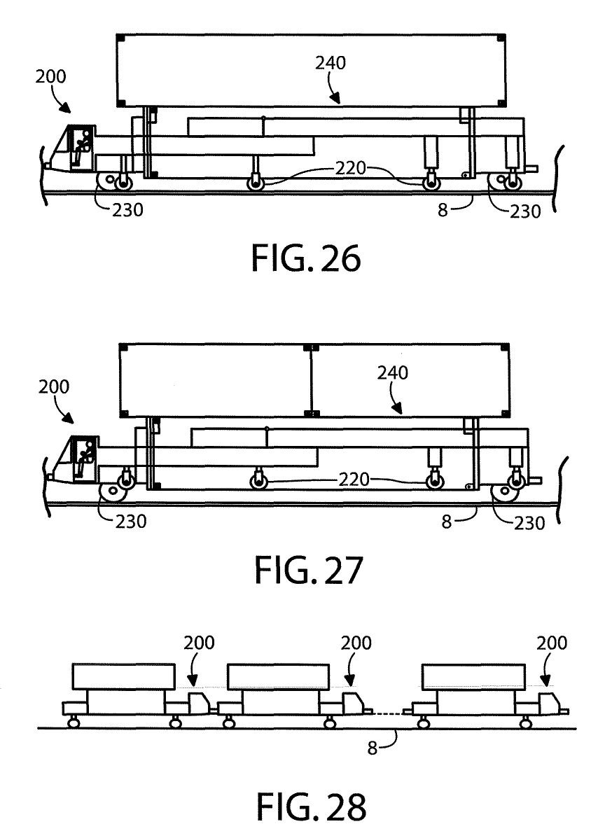

Now in reference to FIGS. 21-28, the vehicle 200 includes a substantially rectangular frame 210 disposed in a horizontal plane. The frame 210 has a pair of end members 212 and a pair of side member 214 defining a central opening 216 thereof. The central opening 216 is sized to receive the container 10 therewithin. An operating cab 218 is mounted on the one end of the frame 210. There is also a predetermined plurality of ground engaging wheel assemblies 220 mounted on each side member 214 of the frame 210. As is with vehicles 100 and 150, the vehicle 200 includes means for generating motive power to at least a pair of the predetermined plurality of ground engaging wheel assemblies 220. Equally as well there is means positioned at each end of the frame 210 for moving the container 10 in a vertical direction. Such container moving means may be a pair of the above described member 120, locking fittings 124 and linear actuators 126, a quartet of linear actuators, each having the stationary portion 128 thereof disposed at the inner corner of the frame 210 and rigidly secured to at least one of the end member 212 and side member 214 and having fitting 124 secured to a distal end of the movable portion 129. In operation, the container 10 is lowered into the central opening 216, for example by a gantry crane (not shown) lifted of the ground and transported onto the intermodal railroad well car 30.

For the reasons to be explained later, the vehicle 200 includes a pair of rail engaging wheel assemblies 230. One rail engaging wheel assembly 230 is mounted at one end of the frame 210. The other rail engaging wheel assembly 230 is mounted at the opposed end of the vehicle 210. Each rail engaging wheel assembly 230 includes a pair of wheels 232 joined by an axle 234. Each rail engaging wheel assembly 230 is mounted so as not to protrude into the central opening 216 and interfere with the container 10 received therewithin.

When the pair of rail engaging wheel assemblies 230 are provided, the vehicle 200 includes a first means for linearly moving each of the predetermined plurality of ground engaging wheel assemblies 220 in the vertical direction and a second means for linearly mowing the each of the pair of rail engaging wheel assemblies 230 in the vertical direction. Each of the first and second wheel moving means is a linear actuator 236 having a stationary portion thereof rigidly attached to a predetermined portion of the frame 210 and having a movable portion attached, either directly or indirectly, to the wheel assembly. The vehicle 200 further includes coupling means, such as coupler 238 for coupling a predetermined plurality of vehicles 200 into a consist. The couplers could be of a conventional railroad type and can be used in combination with energy absorbing devices, for example such as a well known draft gear (not shown)

Thus, the vehicle 200 having rail engaging wheel assemblies 230 and couplers 238 can actually move at least one container 10 to a start of the rail head, reconfigure the wheel arrangement from ground engaging to rail engaging mode and transport the at least one container 10 on a railroad track to a another cargo handling terminal. Upon reaching the another cargo handling terminal, the vehicle 200 can reconfigure the wheel arrangement from rail engaging to ground engaging mode and unload the at least one container 10 in a specific position, including direct placement of the container onto a truck bed. The vehicle 200 can then pick up another container 10 and transport it to the original cargo handling terminal, that the vehicle 200 arrived from, by essentially repeating reconfiguration of the wheel assemblies 220 and 230. Thus, the container 10 is handled only once between two cargo handling terminals.

In the most presently preferred embodiment of the invention, the vehicle 200 has the frame 210 replaced with a frame 240 that is defined by a first generally U-shaped portion 242 carrying the one end of the frame and a second generally U-shaped portion 250 carrying an opposed end of the frame 240 and partially supported on the first generally U-shaped portion 242. There is also a pair of elongated members 260 (only one of which is shown in various figures), each of the pair of elongated members 260 disposed on a respective leg 244 of the first generally U-shaped portion 242 in longitudinal alignment with each leg 252 of the second generally U-shaped portion 250. There is means for reciprocally pivoting the second generally U-shaped portion 250 in a vertical plane relative to the first generally U-shaped portion 242. Such reciprocally pivoting means includes a pair of hinges 270, each of the pair of hinges 270 connecting a distal end of one elongated member 250 with a distal end of a respective leg 252 of the second generally U-shaped portion 250 and a pair of linear actuators 272, each of the pair of linear actuators 272 having a stationary portion 274 thereof pivotally connected to one elongated member 260 and having a terminal end of a movable portion 276 pivotally connected to the respective leg 252 of the second generally U-shaped portion 250.

There is also means for linearly moving the second generally U-shaped portion 250 in a first direction away from the first generally U-shaped portion 242 and in an opposed second direction towards the first generally U-shaped portion 242. Such linearly moving means includes a pair of linear actuators 282, each of the pair of linear actuators 282 having a stationary portion thereof secured to one leg 244 of the first generally U-shaped portion 242 and having a movable portion thereof connected to a respective elongated member 260 disposed on the one leg 244.

In the frame 240, a predetermined plurality of ground engaging wheels 220 are mounted under each leg 252 and a pair of rail engaging wheel assemblies 230 is mounted at the end of the second generally U-shaped portion 250.

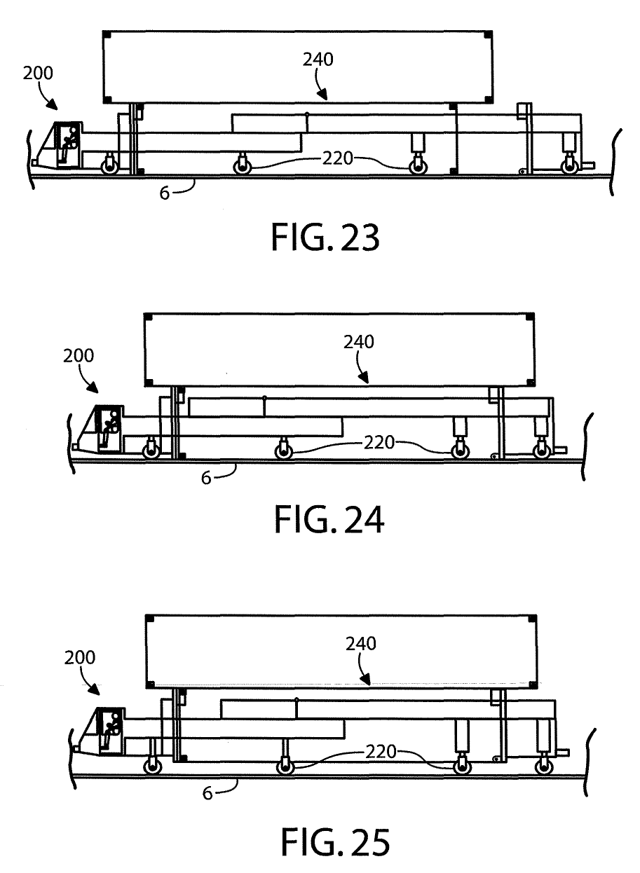

In operation, to load the container 10 or a pair of containers 10, 10′ positioned on the ground surface 6, the vehicle 200, having the second generally U-shaped portion 250 disposed in a vertical plane is backed toward one end of a single container 10 or a pair of vertically stacked containers 10 and 10′, to such point that the front lifting mechanism becomes relatively adjacent to the end section thereof. The second generally U-shaped portion 250 is moved in the first direction and rotated clockwise into a generally vertical position, as best shown in FIG. 22. The vehicle 200 is then partially encases the container 10 after which the second generally U-shaped portion 250 is lowered and is moved in the opposed second direction, as best shown in FIGS. 23-24. The vehicle 200 then elevates the container 10 above the ground surface and travels to the start of the rail head. Upon arriving at the start of the rail head and centering about the rail track 8, the rail engaging wheels are lowered and the ground engaging wheels 220 are raised, enabling the vehicle 200 to travel on such rail track 8

Thus, the vehicle 200 having a frame 240 is of a self-loading type and does not require additional container handling equipment for loading and unloading containers 10. It would be understood, that the vehicle 200 is capable of connecting to and transporting a pair of vertically stacked containers 10, 10′ as well as a pair of small containers 10″ stacked on top of the single container 10, as best shown in FIG. 27.

Furthermore, use of the frame 240 allows the vehicle 200 to adapt to containers 10 of various lengths and thus, the vehicle 200 is capable of handling containers 200 from twenty (20) feet in length to from fifty-three (53) feet in length thus handling any of the presently used containers 10.

One example of using the vehicles 200 is related to a port of Los Angeles that is connected by a dedicated rail line to the Inland Empire facility. Such dedicated rail line is known as Alameda Corridor. Due to lack of sufficient storage space at the docks, generally all unloaded containers 10 are moved wither by trucks or specialized vehicles to the start of the rail line, loaded onto the rail cars and transported to the Inland Empire facility, where the containers 10 are unloaded from the rail cars and are stored for subsequent loading onto the trucks for local deliveries or for loading back onto rail cars for deliveries to other remote cargo handling terminals. On a return trip, the vehicle 200 can place the container 10 directly under the gantry crane for loading onto the marine vessel (not shown).

The consist of vehicles 200 is generally coupled to a conventional locomotive (not shown), although it is also contemplated by the present to provide other means of power. For example, on electrical lines, the vehicle 200 may be provided with catenaries located overhead of the track or with a current collection when a conventional third rail is available. Furthermore, each vehicle 200 may be powered by an internal electric battery (not shown) and be adapted with a conventional recharging device (not shown) operable by wheel rotation for recharging the battery (not shown).

The lifting capability of the vehicle 200 must meet international container gross weight requirements. The vehicle 200 must have lifting and operating cargo load capacity of about one hundred thousand (100,000) lbs. Presently, the maximum gross weight of a single container 10 is limited to forty five (45,000) lbs.

The use of the vehicle 200 would eliminates several conventional handling steps due to its seamlessly integrated operation, while improving air quality, reducing industrial noise and relieving traffic congestion. Its operational efficiency would substantially increase freight throughput and reduce operational costs thus improving operational profits. Conventional trucks are only required for local deliveries.

When vehicles 100, 150 or 200 utilized in sufficient numbers to operate as a unified fleet, the system 20 is advantageous for maximizing efficiencies in ports, terminals, and other dedicated closed loop intermodal freight operations.

Although the present invention has been shown in terms of the container used to haul cargo in marine vessels, it will be apparent to those skilled in the art, that the present invention may be applied to trailer portion of a tractor trailer. In this application the either the vehicle 200 is adapted with a fifth wheel for connecting to the king pin plate of the trailer. Its dimensions can not exceed beyond the width of the trailer or extend beyond the nose of the trailer or extend toward the rear of the trailer beyond a point that when connected to the trailer king pin, can rotate 360 degrees without being obstructed by the trailer's landing gear. At least a portion of such vehicle must be able to move in a vertical manner so that it can connect to trailers of varying heights similar to existing vehicles utilized on truck terminal yard hustlers.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. A system for handling at least one of a container used to haul cargo in marine vessels and a trailer portion of a tractor trailer, said system comprising:
(a) at least one intermodal railroad car having a pair of longitudinal ramps and a pair of ends, each of said pair of ends having a pair of tapered side edges converging in a substantially horizontal plane to form an angle of said each end of about ninety degrees;
(b) at least one vehicle releasably connectable to said at least one of said container used to haul cargo in marine vessels and said trailer portion of said tractor trailer and having at least a predetermined plurality of ground engaging wheel assemblies mounted on each side of said at least one vehicle in a spaced apart relationship for travel on said pair of longitudinal ramps and further having means for moving said at least one of said container used to haul cargo in marine vessels and said trailer portion of said tractor trailer in a vertical direction; and
(c) at least one cargo handling terminal enabling movement of said at least one vehicle onto and from each of said pair of longitudinal ramps and said pair of ends for at least one of loading said at least one of a container used to haul cargo in marine vessels and a trailer portion of a tractor trailer onto and unloading said at least one of a container used to haul cargo in marine vessels and a trailer portion of a tractor trailer from said at least one intermodal railroad car terminal.

2. The system, according to claim 1, wherein said at least one cargo handling terminal includes:
(a) a pair of platforms disposed in a parallel spaced relationship to each other;
(b) a continuous railroad track having a main track portion thereof disposed centrally between said pair of platforms, a pair of spaced apart railroad switches disposed within said main track portion, a pair of track branches, each of said pair of track branches disposed generally adjacent a respective one of said pair of platforms and has each end thereof connected to said main track portion at a respective one of said pair of spaced apart switches;
(c) whereby said each of said pair of ends of said at least one intermodal railroad car having said each end thereof disposed in close proximity to a side edge of said respective one of said pair of platforms;
(d) whereby one of said pair of tapered edges of said each end is disposed substantially parallel to said side edge of said respective one of said pair of platforms; and
(e) wherein a surface of said each of said pair of platforms is disposed generally planar with a surface of said each of said pair of longitudinal ramps and said pair of ends.

3. The system, according to claim 2, wherein said side edge of said respective one of said pair of platforms is attached thereto in one of removable and pivotal manner and overhangs a respective one of said pair of track branches.

4. A railroad car for handling at least one of a container used to haul cargo in marine vessels and a trailer portion of a tractor trailer, said railroad car comprising:
(a) a cargo receiving portion;
(b) a pair of longitudinal ramps, each of said pair of longitudinal ramps having a proximal edge thereof extending along one side of said cargo receiving portion;
(c) a pair of barriers, each of said pair of barriers disposed in a vertical plane and having a lower edge thereof secured to a distal end of one longitudinal ramp; and
(d) a pair of end sills, each of said pair of end sills having each of a proximal end thereof extending along one end of said cargo receiving portion, a distal end formed by a pair of tapered edges converging in said horizontal plane to form an angle of said distal end of about ninety degrees, a top planar surface disposed substantially planar with a top planar surface of said each of said pair of longitudinal ramps, and a pair of side edges, each of said pair of side edges aligned with one distal edge of said longitudinal ramp.

5. The railroad car, according to claim 4, wherein said cargo receiving portion includes:
(a) a pair of side walls;
(b) a pair of end walls;
(c) a well defined by a combination of said side and end walls for receiving said at least one of a container used to haul cargo in marine vessels and a trailer portion of a tractor trailer therein;
(d) wherein said each of said pair of longitudinal ramps having said proximal edge thereof secured to a top edge of a respective one of said pair of side walls; and
(e) wherein said each of said pair of end sill having said proximal end thereof extending along and rigidly secured to each of one of said pair of end walls at a top edge thereof and extending outwardly in a horizontal plane therefrom.

6. The railroad car, according to claim 4, wherein said railroad car includes a pair of bogies adapted for movement over a pair of rail, each of said pair of bogies supporting one end sill of said railroad well car thereon.

7. The railroad car, according to claim 4, wherein said railroad car includes a pair of means for connecting said railroad car into a train consist.

8. A vehicle for handling at least one of a container used to haul cargo in marine vessels and a trailer portion of a tractor trailer, said vehicle comprising:
(a) a substantially rectangular frame disposed in a horizontal plane, said frame having a pair of ends and a pair of sides defining a central opening thereof, said central opening sized to receive said at least one of said container and said trailer portion therewithin;
(b) an operating cab mounted on said one end of said frame;
(c) a predetermined plurality of ground engaging wheel assemblies mounted on each side of said frame;
(d) means for generating motive power to at least a pair of said predetermined plurality of ground engaging wheel assemblies; and
(e) means for moving said at least one of said container and said trailer portion received within said central opening in a vertical direction.

9. The vehicle, according to claim 8, wherein said means for moving said at least one of said container and said trailer portion in said vertical direction includes a quartet of assemblies, each of said quartet of assemblies mounted at a respective corner of said central opening and having each of a vertically disposed elongated member, a locking fitting mounted at an upper end of said elongated member for locking engagement with a corner fitting disposed on said at least one of said container and said trailer portion and a vertically disposed linear actuator having a terminal end of a stationary portion thereof secured to said frame and having a terminal end of a movable portion thereof secured to said elongated member.

10. The vehicle, according to claim 8, wherein said vehicle includes:
(a) a pair of rail engaging wheel assemblies, each of said pair of rail engaging wheel assemblies mounted at a respective end of said frame;
(b) a first means for linearly moving each of said predetermined plurality of ground engaging wheel assemblies in said vertical direction; and
(c) a second means for linearly mowing said each of said pair of rail engaging wheel assemblies in said vertical direction.

11. The vehicle, according to claim 8, wherein said frame includes:
(a) a first generally U-shaped portion carrying said one end of said frame;
(b) a second generally U-shaped portion partially supported on said first generally U-shaped portion;
(c) a pair of elongated members, each of said pair of elongated members disposed on a respective leg of said first generally U-shaped portion;
(d) means for reciprocally pivoting said second generally U-shaped portion in a vertical plane relative to said first generally U-shaped portion; and
(e) means for linearly moving said second portion in a first direction away from said first portion and in an opposed second direction towards said first portion.

12. The vehicle, according to claim 11, wherein said reciprocally pivoting means includes a pair of hinges, each of said pair of hinges connecting a distal end of one elongated member with a distal end of a respective leg of said second generally U-shaped portion and a pair of linear actuators, each of said pair of linear actuators having a terminal end of a stationary portion thereof pivotally connected to said one elongated member and having a terminal end of a movable portion pivotally connected to said respective leg of said second generally U-shaped portion.

13. The vehicle, according to claim 11, wherein said linearly moving means includes a pair of linear actuators, each of said pair of linear actuators having a stationary portion thereof secured to one leg of said first generally U-shaped portion and having a movable portion thereof connected to a respective elongated member disposed on said one leg.

14. A vehicle for handling at least one of a container used to haul cargo in marine vessels and a trailer portion of a tractor trailer, said vehicle comprising:
(a) a body;
(b) a predetermined plurality of ground engaging wheel assemblies mounted on both sides of said body;
(c) means for generating motive power to at least a pair of said predetermined plurality of ground engaging wheel assemblies; and
(d) means for moving said at least one of said container used to haul cargo in marine vessels and said trailer portion of tractor trailer in a vertical direction, said means including each of a vertically disposed member mounted for a linear movement on an opposed end of said body, a pair of locking fittings mounted at an upper end of said member for locking engagement with a respective corner fitting disposed on said at least one of said container and said trailer portion and at least one vertically disposed linear actuator having a terminal end of a stationary portion thereof secured to said opposed end of said body and having a terminal end of a movable portion thereof secured to said member.

15. The vehicle, according to claim 14, wherein said vehicle includes an operating cab mounted on one end of said body.

16. A method for transporting at least one of a container used to haul cargo in marine vessels and a trailer portion of a tractor trailer between a pair of cargo handling terminals, said method comprising the steps of:
(a) providing a powered vehicle having each of ground surface engaging wheels, rail track engaging wheels, means for connecting to said at least one of said container used to haul cargo in marine vessels and said trailer portion of said tractor trailer, and means for reciprocally moving said at least one of said container used to haul cargo in marine vessels and said trailer portion of said tractor trailer in a vertical direction;
(b) configuring said vehicle for travel on said ground surface;
(c) connecting said vehicle to said at least one of said container used to haul cargo in marine vessels and said trailer portion of said tractor trailer;
(d) elevating said at least one of said container used to haul cargo in marine vessels and said trailer portion of said tractor trailer a predetermined distance above ground surface;
(e) traveling, by said vehicle, to a rail head located at one of said pair of cargo handling terminals;
(f) reconfiguring said vehicle for travel on said rail track;
(g) transporting said at least one of said container used to haul cargo in marine vessels and said trailer portion of said tractor trailer to an opposed one of said pair of cargo handling terminals;
(h) reconfiguring said vehicle for travel on said ground surface;
(i) traveling, by said vehicle, to a predetermined location in said opposed one of said pair of cargo handling terminals;
(j) lowering, with said vehicle, said at least one of said container used to haul cargo in marine vessels and said trailer portion of said tractor trailer onto a ground surface of said opposed one of said pair of cargo handling terminals; and
(k) disconnecting said vehicle from said at least one of said container used to haul cargo in marine vessels and said trailer portion of said tractor trailer.

17. A method for transporting at least one of a container used to haul cargo in marine vessels and a trailer portion of a tractor trailer between a pair of cargo handling terminals, said method comprising the steps of:
(a) providing a powered vehicle having each of ground surface engaging wheels, means for connecting to said at least one of said container used to haul cargo in marine vessels and said trailer portion of said tractor trailer and means for reciprocally moving said at least one of said container used to haul cargo in marine vessels and said trailer portion of said tractor trailer in a vertical direction;
(b) providing at least one intermodal railroad car having a pair of longitudinal side ramps and a pair of ends surrounding a cargo receiving portion, each of said pair of ends having a pair of tapered side edges converging in a substantially horizontal plane to form an angle of said each end of about ninety degrees;
(c) providing, at least one cargo handling terminal having a pair of platforms disposed in a parallel spaced relationship to each other;
(d) configuring a portion of a continuous railroad track disposed between said pair of platforms into a main track portion disposed centrally between said pair of platforms and a pair of track branches, each of said pair of track branches disposed adjacent a respective one of said pair of platforms;
(e) connecting said vehicle to said at least one of said container used to haul cargo in marine vessels and said trailer portion of said tractor trailer;
(f) elevating, with said reciprocally moving means of said vehicle, said at least one of said container used to haul cargo in marine vessels and said trailer portion of said tractor trailer a predetermined distance above ground surface;
(g) transporting, by said vehicle, said at least one of said container used to haul cargo in marine vessels and said trailer portion of said tractor trailer onto said at least one intermodal railroad car;
(h) depositing, with said reciprocally moving means of said vehicle, said at least one of said container used to haul cargo in marine vessels and said trailer portion of said tractor trailer onto said cargo receiving portion; and
(i) transporting, by said at least one intermodal railroad well car, said at least one of said container used to haul cargo in marine vessels and said trailer portion of said tractor trailer to an opposed one of said pair of cargo handling terminals.

18. The method, according to claim 17, wherein said step of providing at least one intermodal railroad car includes the step of adapting said cargo receiving portion with a well.
